(19) United States
(12) Patent Application Publication
(10) Pub. No.: US 2007/0036304 A1
(43) Pub. Date: Feb. 15, 2007

(54) Billing of traffic data

(76) Inventors: Uwe Foll, Falkensee (DE); Albert Kain, Wien (AT)

Correspondence Address: STAAS & HALSEY LLP, SUITE 700, 1201 NEW YORK AVENUE, N.W., WASHINGTON, DC, 20005, US

(21) Appl. No.: 10/570,308

(22) PCT Filed: Aug. 16, 2004
(86) PCT No.: PCT/DE04/01841

§ 371 Date: Mar. 2, 2006

(30) Foreign Application Priority Data
Sep. 3, 2003 (DE) 10340531.3

(51) Int. Cl. H04M 15/00

(52) U.S. Cl. 379/114.01

(57) ABSTRACT

To bill traffic data in a simple and efficient manner, a separate virtual transmission channel for the transmission of traffic data is provided between a network unit and a Gateway GPRS Support Node by Gateway GPRS Support Nodes for traffic data and billing is carried out for said virtual transmission channel.

### CROSS REFERENCE TO RELATED APPLICATIONS

This application is based on and hereby claims priority to PCT Application No. PCT/DE2004/001841 filed on Aug. 16, 2004 and German Application No. 10340531.3 filed on Sep. 3, 2003, the contents of which are hereby incorporated by reference.

### BACKGROUND OF THE INVENTION

The invention relates to a method and an apparatus for billing for traffic data in a communication network.

Methods are currently being provided for billing for applications such as the downloading of games, pictures, videos etc. on the basis of IP address and port filtering. Only by these methods is it possible to distinguish between the applications. However, since different codes in a virtual transmission channel (PDP context) can adversely affect one another and the performance or the quality of service (QoS) provided can be restricted further, this may not be sufficient for individual services or applications. Applications such as online banking, auctions, internet trading etc. require a PDP context for transmission (a virtual transmission tunnel or channel through a third-generation (3GPP) cellular mobile radio network) in order to ensure appropriate billing and/or transmission security. By way of example, higher-quality contents may have their billing performed using tariff models which have been matched to these contents. In this case, the virtual transmission channel (PDP context) can be used to ensure clear association of the charges for the application's resource use.

The specification 3GPP TS 23.060 V5.6.0 (2003-06) 3^{rd Generation Partnership Project; Technical Specification Group Services and System Aspects; General Packet Radio Service (GPRS); Service Description; Stage} 2 (Release 5) describes the use of virtual transmission channels between a mobile terminal and a Gateway GPRS Support Node (GGSN) in section 9 (from page 120 onward). This specification explains activation, deactivation, modification etc. of the virtual transmission channels.

From the document EP-A-1 096 742, it is known that to support different quality of service (QoS) profiles for transmitting components of a multimedia stream between a terminal and a GGSN it is possible to use “PDP subcontexts” or “Secondary PDP contexts” associated with the original PDP context.

### SUMMARY OF THE INVENTION

One possible object of the present invention is to propose an efficient and simple way of billing for traffic data.

The inventors propose that the Gateway GPRS Support Node (GGSN) takes an association as a basis for providing a respective dedicated virtual transmission channel for an application for transmitting traffic data from the application. In this case, at least one association rule for the billing for the application's traffic data in question can be used to make an association. Information regarding the billing for the application's traffic data can be forwarded from the Gateway GPRS Support Node (GGSN) to a billing unit. In addition, an IP tunnel can be used for securely transmitting the application's traffic data via a virtual transmission channel. A fundamental advantage is that it is possible to bill for traffic data from a network unit in a very simple and efficient manner.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a simplified architecture for transmitting and billing for traffic data from an application using a virtual transmission channel,

FIG. 2 shows a Gateway GPRS Support Node based on one embodiment of the invention.

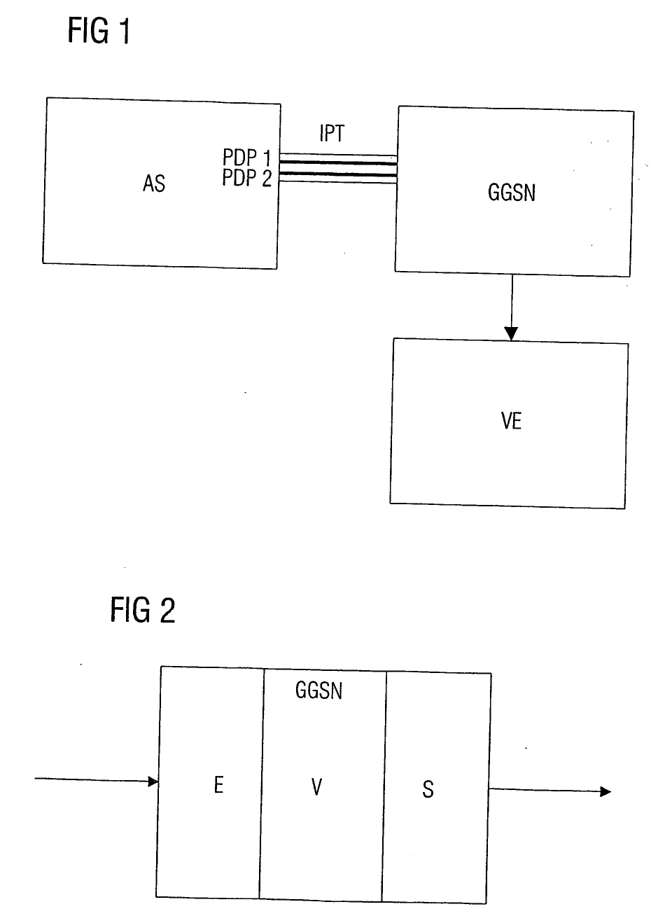

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Figure shows a simplified architecture for transmitting and billing for traffic data from an application using a virtual transmission channel PDP 1, PDP 2 in a cellular mobile radio network. A different communication network is likewise conceivable. Traffic data from a network unit AS, such as from an application server, a service server or the like, are transmitted to a Gateway GPRS Support Node GGSN. As a network function with appropriate access rights, the network unit AS can reserve itself and initiate an exclusive virtual transmission channel PDP 1, PDP 2 provided by the Gateway GPRS Support Node GGSN. This must be a network function so that an appropriate level of security for billing for traffic data is assured for particular applications. Such applications may be online banking, auctions, internet trading, credit card payment etc. To distinguish between the individual items of traffic data, a processing and association unit V at a Gateway GPRS Support Node GGSN, such as an IP flow function unit, stores an association rule relating to the billing for traffic data. If, on the basis of this association rule, the Gateway GPRS Support Node GGSN establishes that the billing for traffic data in a data stream which has just been set up needs to be metered, for example on the basis of time, a dedicated virtual transmission channel (PDP context) PDP 1, PDP 2 is provided for the traffic data in the data stream. For the virtual transmission channel PDP 1, PDP 2, the precise time of existence can be ascertained and the information can be forwarded to a billing unit VE for billing purposes. It is thus also possible to bill for only portions of an application. Such an application portion is called an application in line with the above discussion. This can be done by the Gateway GPRS Support Node GGSN. The method and the apparatus can be used both for prepaid billing (offline billing) and for invoiced billing (online billing). Thus, a network unit AS can provide traffic data for an application using an appropriate billing association rule. A

Gateway GPRS Support Node GGSN uses this association rule to provide a dedicated virtual transmission channel PDP 1, PDP 2 for the traffic data. This means that there is no need for any port filtering of the traffic data by the Gateway GPRS Support Node GGSN or another network unit. The use of an IP tunnel IPT between the network unit AS and the Gateway GPRS Support Node GGSN allows a significant improvement in security. This may be of interest in the case of an internet access portal for shares trading, for example. It is thus possible to ensure, from the application on the terminal to the network unit AS, that no other application has access to the traffic data. The terminal used may be a mobile radio terminal, a handheld unit, a computer, a Notebook or the like.

FIG. 2 shows a Gateway GPRS Support Node GGSN with a reception unit E for receiving traffic data from an application in a data stream, a processing and association unit V for creating an association and for providing a dedicated virtual transmission channel PDP 1, PDP 2. A transmission unit S at the Gateway GPRS Support Node GGSN is then used to transmit the application's traffic data via a dedicated virtual transmission channel PDP 1, PDP 2. Information created by the processing and association unit V for the purpose of billing for the application's traffic data which are transmitted via a dedicated virtual transmission channel PDP 1, PDP 2 can be forwarded from the transmission unit S to a billing unit VE for billing purposes.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method for billing for traffic data from applications in a communication network, the traffic data of each application being sent between a service server and/or application server and a Gateway General Packet Radio Service (GPRS) Support Node (GGSN), the method comprising:
providing a dedicated virtual transmission channel at the Gateway General Packet Radio Service (GPRS) Support Node (GGSN) for each application, the dedicated virtual transmission channel being provided between the service server and/or application server and the Gateway General Packet Radio Service (GPRS) Support Node (GGSN); and
using the Gateway GPRS Support Node to perform billing for each virtual transmission channel.

17. The method as claimed in claim 16, wherein the virtual transmission channel is a packet data protocol (PDP) virtual context.

18. The method as claimed in claim 16, wherein the Gateway GPRS Support Node for traffic data of the application which are sent by the service server and/or application server takes at least one association rule as a basis for making an association for the billing of the traffic data of the application.

19. The method as claimed in claim 18, wherein the Gateway GPRS Support Node comprises a processing and association unit for making the association relating to the billing for traffic data of the application.

20. The method as claimed in claim 16, wherein information for billing the traffic data of the application is forwarded from the Gateway GPRS Support Node to a billing unit.

21. The method as claimed in claim 16, wherein between the service server and/or application server and the Gateway GPRS Support Node, an IP tunnel is used for transmitting the traffic data of the application.

22. The method as claimed in claim 16, wherein the communication network is a cellular mobile radio network.

23. The method as claimed in claim 16, wherein
the traffic data is sent to a terminal, and
the terminal is a mobile radio terminal, a handheld unit, a computer, and/or a Notebook computer.

24. The method as claimed in claim 19, wherein
a plurality of association rules are used to associate billing information, and
at least one of the association rules is signaled by the service server and/or application server to the Gateway GPRS Support Node.

25. The method as claimed in claim 17, wherein the Gateway GPRS Support Node for traffic data of the application which are sent by the service server and/or application server that takes at least one association rule as a basis for making an association for the billing of the applications traffic data.

26. The method as claimed in claim 25, wherein the Gateway GPRS Support Node comprises a processing and association unit for making the association relating to the billing for traffic data of the application.

27. The method as claimed in claim 26, wherein information for billing the traffic data of the application is forwarded from the Gateway GPRS Support Node to a billing unit.

28. The method as claimed in claim 27, wherein between the service server and/or application server and the Gateway GPRS Support Node, an IP tunnel is used for transmitting the traffic data of the application.

29. The method as claimed in claim 28, wherein the communication network is a cellular mobile radio network.

30. The method as claimed in claim 29, wherein
the traffic data is sent to a terminal, and
the terminal is a mobile radio terminal, a handheld unit, a computer, and/or a Notebook computer.

31. An apparatus for billing for traffic data from applications in a communication network, comprising:
a processing and association unit provided at a Gateway General Packet Radio Service (GPRS) Support Node (GGSN), the traffic data of each application being sent between a service server and/or application server and the Gateway GPRS Support Node, the processing and association unit providing a dedicated virtual transmission channel for each application, the processing and association unit also performing billing for the virtual transmission channel;
a reception unit provided at the Gateway GPRS Support Node to receive the traffic data of the application via the virtual transmission channel; and
a transmission unit provided at the Gateway GPRS Support Node to transmit the traffic data of the application via the virtual transmission channel.

32. The apparatus as claimed in claim 31, wherein between the service server and/or application server and the Gateway GPRS Support Node, an IP tunnel is used for transmitting the traffic data of the application.

33. The apparatus as claimed in claim 31, wherein the processing and association unit at the Gateway GPRS Support Node is provided for the purpose of associating the billing on the basis of at least one association rule for the traffic data of the application.

34. The apparatus as claimed in claim 31, wherein the communication network is a cellular mobile radio network.
